(19) United States
(12) Patent Application Publication
(10) Pub. No.: US 2023/0169447 A1
(43) Pub. Date: Jun. 1, 2023

(54) SYSTEMS, APPARATUS, AND COMPUTER-IMPLEMENTED METHODS FOR MONITORING PACKAGES IN TRANSIT THROUGH A LOGISTICS NETWORK

(71) Applicant: FedEx Corporate Services, Inc., Collierville, TN (US)

(72) Inventors: Bala Vaidyanathan, Collierville, TN (US); George Richardson, Germantown, TN (US); Chinnatat Methapatara, Memphis, TN (US); Christopher Bochman, Cordova, TN (US); Gopal Narasimhan, Collierville, TN (US)

(21) Appl. No.: 17/586,763

(22) Filed: Jan. 27, 2022

Related U.S. Application Data
(60) Provisional application No. 63/284,615, filed on Nov. 30, 2021.

(51) Int. Cl. G06Q 10/08; G06Q 10/06

(52) U.S. Cl. CPC G06Q 10/0833; G06Q 10/0635; G06Q 10/0838

(57) ABSTRACT

Methods, apparatus, and systems are described for monitoring packages in transit within a network to determine which packages are at risk of being delivered after a stated commit time. In general, package fingerprints that define events expected to occur for the package while in transit and define thresholds for those events are generated from historical data of events occurring in the logistics network for packages in transit. Those thresholds may be applied to packages in real time as the events for the packages are occurring while the packages are in transit to then determine a level of risk for any package that has an event that occurs after the threshold for the event. Attention can be given to those packages that are at a sufficient level of risk.

### RELATED APPLICATIONS

The present application claims priority to U.S. Provisional Application No. 63/284,615, filed on Nov. 30, 2021, and entitled SYSTEMS, APPARATUS, AND COMPUTER-IMPLEMENTED METHODS FOR MONITORING PACKAGES IN TRANSIT THROUGH A LOGISTICS NETWORK, the entire contents of which are incorporated herein by reference.

### FIELD OF THE DISCLOSURE

The present disclosure generally relates to systems, apparatus, computer-readable media, and methods in the field of shipment management and logistics and, more particularly, to various aspects involving systems, apparatus, computer-readable media, and methods for various enhanced and improved logistics monitoring abilities to determine packages at risk of being delivered later than a stated commit time.

### BACKGROUND

Logistics networks transport packages from an origin to a destination. Large logistics networks may operate at an immense scale where millions of packages are transported throughout countries and from country to country globally on a daily basis. Such a large logistics network may involve several hundred planes, tens of thousands of trucks/vans, and several hundred thousand team members. Furthermore, these logistics networks may be highly complex in operation, for instance with packages that are day definite, time definite, with different transit days, hundreds of service types, and moved through different modes of transportation including road, air, and rail. The network operation may vary over-time and by day of the week. Additionally, the network may be governed by seasonality with peak volumes roughly 1.5 to 2 times nonpeak volumes. Furthermore, new facilities and new transportation legs and modes may be added on an ongoing basis so that network plans need to continually evolve to adapt to the changing volume and network configuration.

For any given package being transported by the logistics network, the service type that is purchased may state a commit time for delivery of the package from the origin to the destination. Thus, a customer may purchase the level of service needed for a particular package. However, packages in transit through the logistics network may experience delays or other exceptions to the normal transport schedule due to any number of reasons. Weather, traffic, equipment malfunctions, internal network operation errors, and the like affect the transporting of the packages. Therefore, some packages may be delivered after the stated commit time.

While a later than expected delivery may be innocuous in some circumstances, in others the later than expected delivery may have more significant consequences. Therefore, it is of particular importance that an awareness of packages that will be delivered late be available. Yet, the conventional computer systems of the logistics network lack the ability to provide such package-level insight to the personnel of the logistics network operator or to the customer. Therefore, such a determination may require a manual investigation of potentially hundreds or even thousands of packages in transit at any given time for any one large scale customer. Monitoring packages in transit to determine which packages may potentially be late to the destination becomes an enormous and burdensome task requiring a substantial and expensive commitment of personnel and time which may not result in the identification of all packages of concern.

To address one or more of these issues, there is a need for a more capable, intelligent configuration of equipment to learn from the historical operation of the network and to apply those learnings when monitoring the transporting of packages within the logistics network to identify those packages at risk of being delivered later than expected.

### SUMMARY

In the following description, certain aspects and embodiments will become evident as being generally directed to technical solutions for logistics operations involving providing processing systems with the ability to train a model of network operations that specifies thresholds for events that the packages are expected to encounter while in transit between the origin and the destination based on an analysis of historic logistics network data. Further, certain aspects and embodiments will become evident as being generally directed to monitoring events for packages relative to the specified thresholds to determine which packages are at risk of being delivered later than a stated commit time so that those packages at risk may be identified for personnel and/or customers. It should be understood that the aspects and embodiments, in their broadest sense, could be practiced without having one or more features of these aspects and embodiments. It should be understood that these aspects and embodiments are merely exemplary.

In one aspect of the disclosure, a computer system is described that is for monitoring the transport of packages within a logistics network. The computer system includes an interface to at least one logistics network data source. The computer system includes a first data storage module containing historical network data that is coupled to the interface to build the historical network data from a data feed from the logistics network data sources. The computer system includes a second data storage module containing package transport model data. The computer system includes a first processing system that accesses the data storage device and applies machine learning to the historical network data to train the package transport model data. The first processing system captures data-driven patterns inclusive of expected location of historical events, expected type of historical events, and expected time of historical events. From the data-driven patterns, the first processing system creates a set of predicted events for a hypothetical package being transported from a first location to a final location through the logistics network and determines a threshold for each of the predicted events in order for the hypothetical package to arrive at the final location by a stated time, each threshold relating to the expected time of a predicted event to occur for the hypothetical package where the predicted event relates to expected location and expected type. The computer system includes a second processing system that is coupled to the interface to receive live data from the logistics network including data about a real package in transit, the second processing system accesses the transport model data from the second data storage to apply the thresholds to the predicted events for the real package and the second processing system assesses whether the real package is on schedule to be delivered to the final location in relation to each predicted event based on application of the thresholds.

In another aspect of the disclosure, a computer system is described that is for finding a level of risk of packages being delivered to a final location after a stated time. The computer system includes a first processing system that determines a threshold for each expected event for a package between a first location and the final location. The computer system includes a second processing system that, while the package is in transit, for each expected event determines if the event occurs by the threshold corresponding to each expected event. At a point in time during the transit of the package, the second processing system determines a level of risk of the package being delivered after the stated time based on an amount of delay beyond the threshold of the most recent expected event.

Another aspect of the disclosure focuses on a computer-implemented method of finding a level of risk for package being delivered to a final location after a stated time. The method involves determining a threshold for each expected event for a package between a first location and the final location. The method involves, while the package is in transit, for each expected event determining if the event occurs by the threshold corresponding to each expected event. Additionally, the method involves, at a point in time during the transit of the package, determining a level of risk of the package being delivered after the stated time based on an amount of delay beyond the threshold of the most recent expected event.

Another aspect of the disclosure focuses on a computer-implemented method for monitoring the transport of packages within a logistics network. The method involves applying machine learning to historical network data for the logistics network to train package transport model data. The machine learning trains the package transport model data by capturing data-driven patterns inclusive of expected location of historical events, expected type of historical events, and expected time of historical events. The machine learning further trains the package transport model data from the data-driven patterns by creating a set of predicted events for a hypothetical package being transported from a first location to a final location through the logistics network and by determining a threshold for each of the predicted events in order for the hypothetical package to arrive at the final location by a stated time, each threshold relating to the expected time of a predicted event to occur for the hypothetical package where the predicted event relates to expected location and expected type.

Each of these aspects respectively effect improvements to the technology of logistics operations involving monitoring events for packages in transit through the logistics network to find those packages at risk of being delivered after the stated commit time. Additional advantages of this and other aspects of the disclosed embodiments and examples will be set forth in part in the description which follows, and in part will be evident from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments according to one or more principles of the invention and together with the description, serve to explain one or more principles of the invention. In the drawings,

FIG. 1 is a diagram of an exemplary logistics network that includes package data collection that may be used to train a model of logistics network operations and also for purposes of monitoring packages in real time by applying the model to live package data to determine risk of packages within the logistics network being delivered after a stated time in accordance with embodiments of the invention.

FIG. 2 is a diagram of an exemplary computer system which may include one or more processing systems implementing one or more modules to train the model of network operations and implementing one or more modules to monitor packages in real time by applying the model to determine risk.

FIG. 3 is a diagram demonstrating three exemplary aspects of monitoring packages to detect those at risk of being delivered after the stated time including model training, model scoring, and configurable output.

FIG. 4 is a flow diagram illustrating an exemplary method of training a model of logistics network operations including predicted events, associated thresholds for the predicted events, and risks associated with real time delayed occurrence of events.

FIG. 5 is a diagram of exemplary modules that may be performed by processing systems such as those shown in FIG. 2 to train the model of logistics network operations.

FIG. 6 is an exemplary histogram showing the distribution of event slack times as set forth in FIGS. 4 and 5 and demonstrating a determination of an event threshold to be included in the model from the distribution of event slack times.

FIG. 7 is a flow diagram illustrating an exemplary method of determining event thresholds for predicted current events expected to occur for packages being transported within the logistics network.

FIGS. 8A and 8B show a flow diagram illustrating an exemplary method of determining location and type of predicted next events expected to occur for packages being transported within the logistics network after the occurrence of corresponding current events.

FIGS. 9A and 9B show a flow diagram illustrating an exemplary method of determining the values of a risk table that provides a risk associated with an amount of delay for each predicted event.

FIG. 10 is a flow diagram illustrating an exemplary method of using the model to score risk for a package in relation to the predicted events that involves both reactive and proactive scoring of risk for the predicted events.

FIG. 11 is a flow diagram illustrating an exemplary method of using the model to provide the reactive scoring of risk for a package in relation to the occurrence of a predicted current event.

FIG. 12 is a flow diagram illustrating an exemplary method of using the model to provide the proactive scoring of risk for a package in relation to the non-occurrence of a predicted next event that follows the occurrence of a current event.

FIG. 13 is a flow diagram illustrating an exemplary method of a risk aggregator aspect of the model to establish the level of risk for a predicted event from the standpoint of being a predicted next event that becomes a current event once the predicted event has occurred.

FIG. 14 is a flow diagram illustrating an exemplary method of re-routing packages in response to the level of risk determined by the model.

FIG. 15 is a diagram illustrating an exemplary timeline of events for a package that becomes re-routed due to the level of risk.

FIG. 16 is a flow diagram illustrating an exemplary method of finding risk to a package from pre-shipment inclement condition advisories in relation to the expected transport path as provided by the model.

FIG. 17 is a screen capture illustrating an exemplary user interface to present information about packages in transit within the logistics network including those at risk of being delivered later than a stated time.

FIG. 18 is a screen capture illustrating an exemplary user interface to present information about packages in transit within the logistics network including those at varying levels of risk of being delivered later than a stated time.

FIG. 19 is a screen capture illustrating an exemplary user interface to present information about packages in transit within the logistics network including the location where events are occurring that indicate packages are at risk of being delivered later than a stated time including filters for controlling the nature of the information being displayed.

### DESCRIPTION OF THE EMBODIMENTS

Reference will now be made in detail to various exemplary embodiments. Wherever possible, the same reference numbers are used in the drawings and the description to refer to the same or like parts. However, those skilled in the art will appreciate that different embodiments may implement a particular part in different ways according to the needs of the intended deployment and operating environment for the respective embodiments.

In general, the following describes various embodiments of systems, apparatus, computer-readable media, and methods that create a model of logistics network operations from the standpoint of the timing and location of events that packages encounter while in transit within the logistics network. Thresholds are determined for the events that are expected to occur for packages where those thresholds provide a manner of determining in relation to each event a package is predicted to encounter while in transit whether the package is at risk of being delivered later than a stated time such as a commit time that a recipient expects to be met.

Those skilled in the art will also appreciate that each embodiment described herein effects improvements to particular technologies, such as systems that monitor package shipments, logistics operations, and related infrastructure. Each embodiment describes a specific technological application that leverages and applies a particular embodiment of creating a model of logistics network events and using the model to monitor packages in transit through the logistics network to identify those packages at risk of being delivered after the stated commit time. The monitoring to identify those packages at risk allows related actions to be taken within the logistics network as well as at the customer level where the specific technological application improves or otherwise enhances such technical fields as explained and supported by the disclosure that follows.

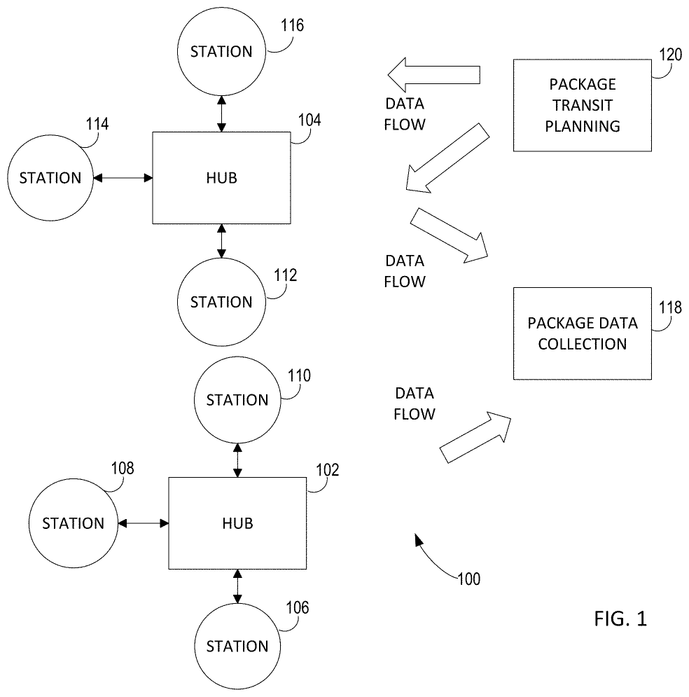

FIG. 1 shows a portion of an exemplary logistics network 100 that is used to transport packages between an origin and a final location also referred to as a destination. The logistics network 100 of this example may include any number of facilities. Hubs 102, 104 are an example of a facility where packages arrive, are sorted so as to be transported forward to another hub or be transported to a station 106, 108, 110, 112, 114, or 116 associated with the hub. The packages may be transported from a hub 102, 104 to an associated station where the package may then be routed to the destination.

As the package is being transported through the logistics network 100, the package encounters various events where information about the package is gathered by the logistics network 100. This data is then collected at a computer system 118 such as one or more server computers maintaining one or more databases of the package and event information. These events may be scan events such as where a barcode, QR code, or similar readable code from a label or from an electronic circuit such as a radio frequency identification circuit (RFID) tag located on the package may be scanned. These events may also include communications initiated by a transmitter on the package, such as an active RFID tag, near field transmitter, or Bluetooth® device transmitting the package information to receiving devices.

These events may occur at each milestone for the package in transit. For instance, an event may occur upon the package being picked up at a remote location. Another event may occur when the package arrives at a station. Another event may occur as the package passes through a sorting or loading stage within the station. Another event may occur as the package departs the station for a hub. Another event may occur as the package arrives at the hub. Another event may occur as the package is sorted at the hub, and so on. Each event identifies the package as well as the time and location of the event so that the location of the package at any given time within the logistics network 100 is known.

The particular path and timing a package follows as it is in transit through the logistics network is defined by a plan. A package transit planning system 120, such as one or more server computers, may determine an appropriate transit plan for each package and the data is provided to the various facilities including the hubs and stations so that the package identified at each event can be sorted and loaded to follow the path set forth in the plan. The plan may also specify the stated time by which the package should be delivered to the final destination where the path may be chosen. However, the package may experience delays and other departures from the initial plan due to various factors.

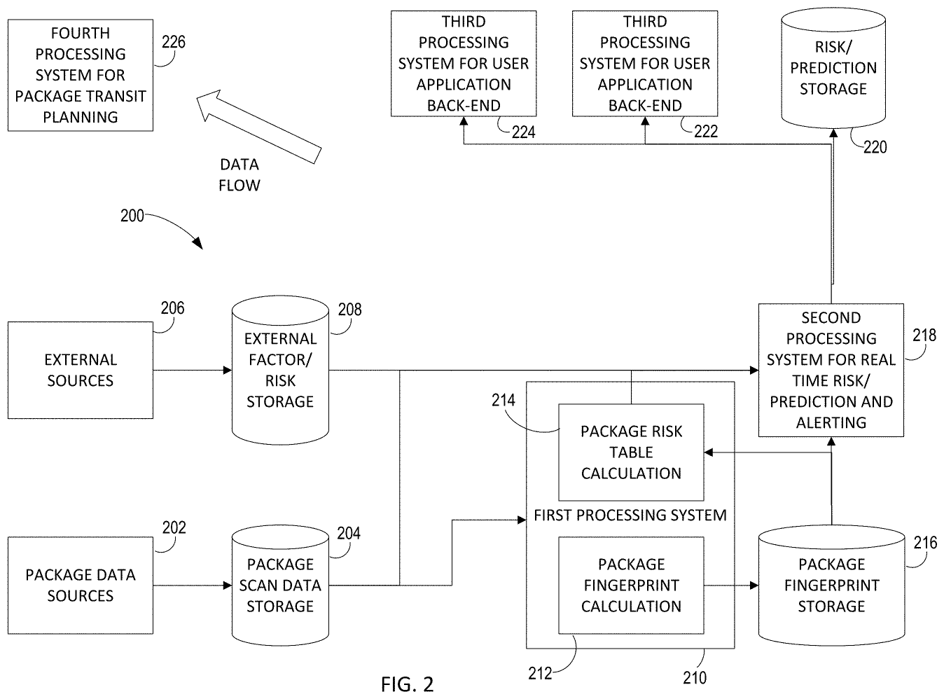

FIG. 2 shows an exemplary computer system 200 that may be used to model the logistics network based on historical data that has been captured at the package data collection system 118. The exemplary computer system 200 may also then apply the model to real time data streaming from the logistics network 100 to determine the level of risk of any packages being delivered later than the stated time. The computer system 200 may include an interface 202 to the data sources of the logistics network 100 including the data collection 118. The data streaming from the logistics network 100 to the computer system 200 via the package data interface 202 may be prepared and cleansed using typical data cleansing techniques. For instance, the data interface may filter out events that may be unrelated to training or scoring activities for the model.

A package data storage module 204 collects the prepared historical network event data for use in subsequent processes for both training and scoring activities for the model. For model training purposes, the package data storage 204 may provide historical event data for the logistics network 100 to a first processing system 210. For model scoring purposes, the package data storage 204 may provide live data as it is being streamed from the logistics network 100 to a second processing system 218. While the first processing system 210 and second processing system 218 are shown as separate items in FIG. 2, it will be appreciated that these processing systems may be provided by a single computer or single collection of computers that implement separate functional modules for model training and scoring purposes. Furthermore, it will be appreciated that when referring to computers, server computers, computer systems, and processing systems herein, these may include one or more general purpose-programmable processors, one or more application specific processors, hardwired digital logic, and/or various combinations of such devices.

The first processing system 210 may perform operations to train the model representative of events occurring within the logistics network 100 from the historical event data that has been captured from the logistics network 100 over a period of time. Furthermore, the first processing system 210 may repetitively perform the model training to account for new aspects of the logistics network 100 that may occur over time. For instance, new events may be introduced within an existing collection of facilities and these new events are captured within the historical data maintained within the package data storage 204 so that the first processing system 210 may continue to train the model to incorporate the new events. Furthermore, the addition of new facilities may introduce new events into the historical data maintained within the package data storage so that the first processing system 210 may continue to train the model to incorporate the new events corresponding to the new facilities. In this manner, the computer system 200 allows the model to scale with the logistics network 100 and thereby maintain a model of the network 100 that is current so that real time application of the model for scoring accounts for the evolving network 100.

Furthermore, the computer system 200 is not confined to a single logistics network 100 or operator of the logistics network 100. The computer system and specifically the first processing system 210 may incorporate different networks when training the model so long as the historical event data from these additional networks is available, regardless of operator. Additionally, the computer system 200 and specifically the second processing system 218 may score the model against packages within the different networks so long as the streaming of live event data from the different networks is available.

With a focus on the first processing system 210, in this exemplary computer system 200 two sub-systems providing machine learning to train the model are included. A first sub-system 212 implements machine learning from the historical event data that has been captured to provide package fingerprint calculations to create package fingerprints that define the model. A package fingerprint describes events that a package is expected to encounter when in transit from a particular first location such as the origination location of the package to a particular final location that is the destination of the package. The events captured from the network that make up the historical data as well as the events specific in the package fingerprint are identified as having several characteristics. For instance, the events may be identified has having the following three characteristics: a location where the event happens, the type of event that happens, and a time that the event happens.

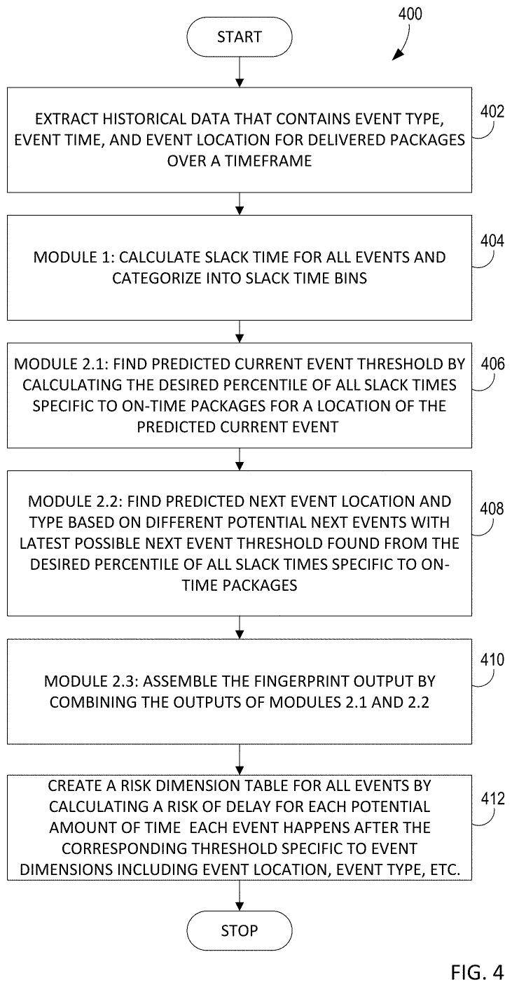

The time included in the package fingerprint of the model that is specified for an event is the latest time that the event should happen for a hypothetical package that is on-schedule to be delivered to the final location by the stated time. Thus, this time of the event in the model is referred to as a package threshold. This package threshold is determined through machine learning from the historical data, where events of a given location and of a given type that are represented within the historical data typically occur over a range of times. Examples of the machine learning operations of the first sub-system 212 that produce the thresholds are described below in greater detail with reference to FIGS. 4-8B.

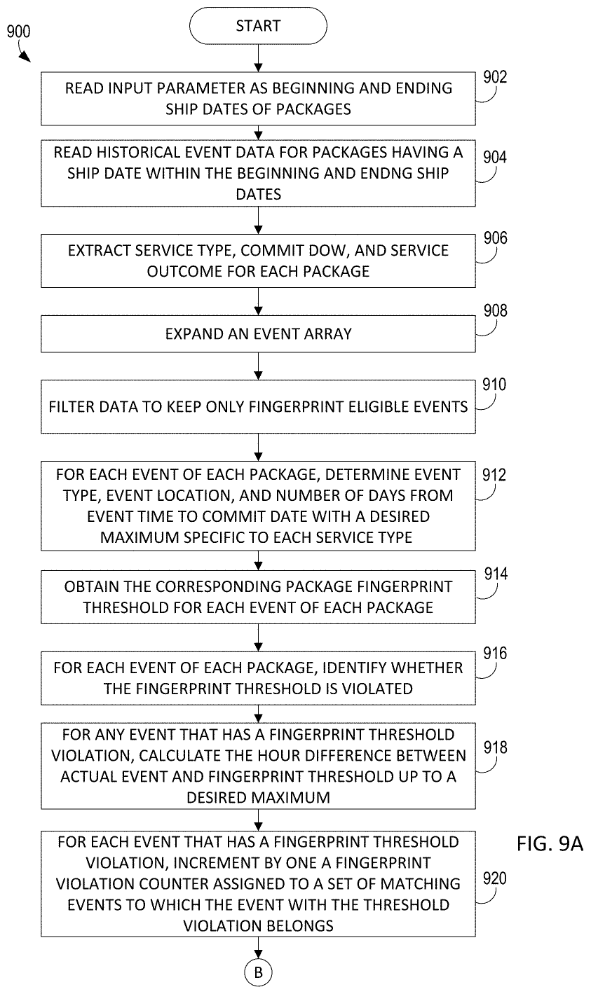

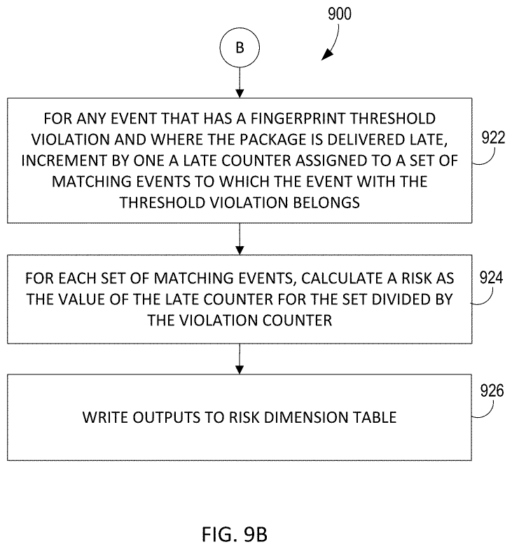

The first processing system 210 stores the package fingerprints for all known package events determined by machine learning from the historical data and forming the model as package transport model data in package fingerprint storage module 216 which may be a database. The package fingerprint data can then be made available from the package fingerprint storage 216 to other sub-systems of the first processing system 210 including a second sub-system 214 for package risk table calculation. The package fingerprint data is used by the second sub-system 214 to find a level of risk of being delivered to a particular final location for a hypothetical package for different amounts of delay beyond the package threshold for each predicted event in the package fingerprint for the hypothetical package. The determination of entries into the risk table at the second sub-system 214 is described in more detail below in relation to FIGS. 9A and 9B.

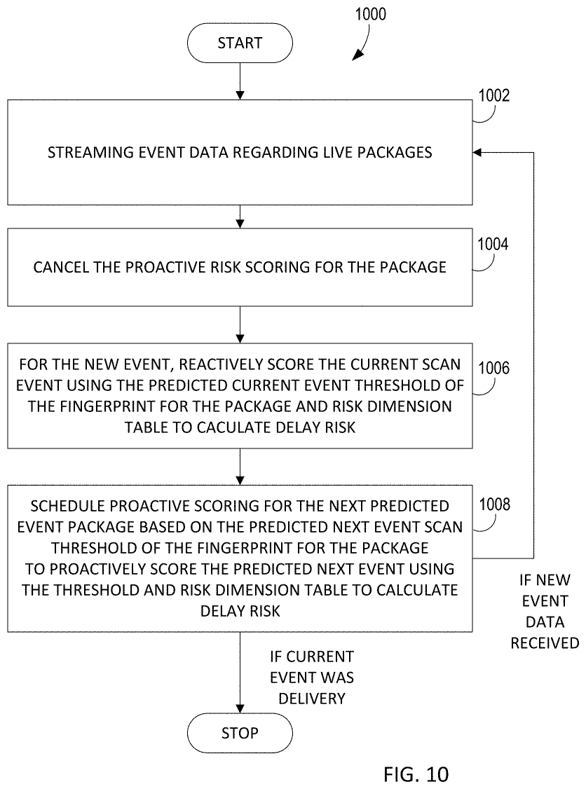

The risk table of second sub-system 214 and the package fingerprint from the first sub-system 212 and storage 216 are made available to the second processing system 218 for purposes of model scoring against the real time package data. The second processing system 218 applies the package thresholds when using model scoring to determine an amount of delay of the predicted event beyond the package threshold for a real package in real time by also receiving the live data being streamed from the logistics network 100. Upon determining the amount of delay, if any, that has occurred for the real package at a particular predicted event, the second processing system 218 may then find the corresponding level of risk of the package being delivered to the final location after the stated time. The determination of the level of risk for a real package in transit is described in more detail below in relation to FIGS. 10-13.

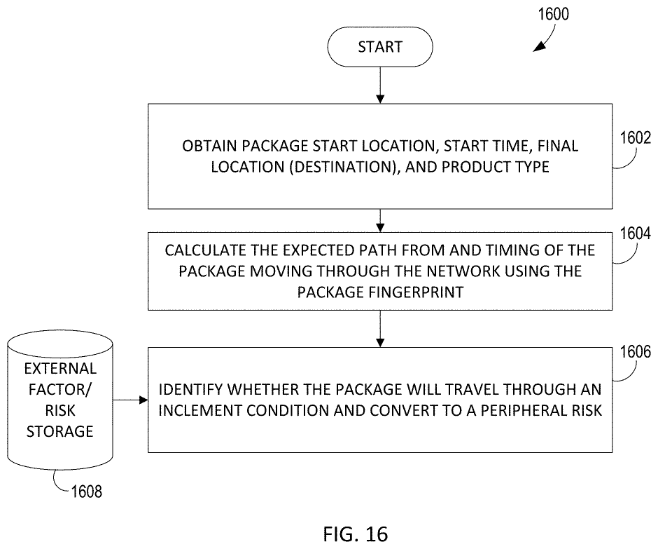

In addition to the risk determination based on the risk table from the second sub-system 214, the second processing system 218 may also receive risk information for external factors that create inclement conditions for transporting packages. External sources 206 of data related to such external factors may stream data to the computer system 200 and more specifically to an external factor/risk storage 208 and to the second processing system 218. For instance, external factors may include weather, traffic, power outages, and the like that may result in a delay that can be forecasted in advance of a package being transported from one location to another rather than only determined in relation to a package threshold for an event. The second processing system 218 may make such an advance prediction of delay risk by having the predicted path from the package fingerprint to then assess the forecasted delay risk for each leg of the journey the package is expected to make. The determination of risk from the from external sources is described in more detail below in relation to FIG. 16.

Once a level of risk has been assessed for a real package in transit within the logistics network 100, the information about that real package and the level of risk are made available to downstream consumers. Alerts may be generated immediately from the second processing system 218 to call attention to specific situations regarding packages missing events or having a level of risk that is significant. Furthermore, the information about the package and level of risk may be provided to another storage device 220 that maintains the most current risk assessment for each real package currently in transit within the logistics network 100. Additionally, one or more third processing systems 222, 224 may access the information to provide the information to one or more entities via user applications. For instance, one system 222 may act as a web server and provide information to customers expecting to receive the packages via a data feed to a dedicated application or to a website that the customer accesses via the Internet. Another system 224 may provide information to personnel of the shipping entity that operates the logistics network 100.

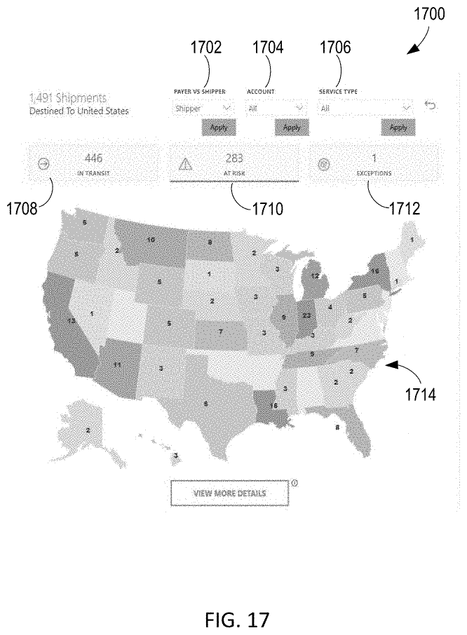

The person viewing the information provided from the system 222 or 224 as a display on a device may be able to quickly see which packages are at risk of being delivered after the stated time. Therefore, the person is not required to sort through information for every package that the person wishes to monitor for an on-time delivery status since only those packages at risk of being delivered after the stated time require attention. Furthermore, the person may be given further options including viewing package-specific information for any package at risk of being delivered after the stated time. Personnel of the shipping entity may be given additional features including the ability to filter the information for any packages in the logistics network 100 such as by customer and identify the specific facilities, days of the week, and the like within the logistics network 100 where packages are becoming at risk to further identify potential points of failure within the network. Screen captures of examples of such user interfaces are discussed in more detail below with reference to FIGS. 17-19.

In addition to providing information for display regarding packages being at risk of a later than stated delivery time, the information regarding an at-risk package may be shared with a fourth processing system 226 that performs the package transit planning for the logistics network. The fourth processing system 226 may be a sub-system of the package transit planning system 120 which makes the determination of the actual path through the logistics network 100 that a package will follow to be delivered to the final location. Thus, at any given facility along the path intended for the package, the fourth processing system 226 may determine that a better route is available for purposes of increasing the likelihood that a package is delivered by the stated time. Upon the package taking the new route, the second processing system 218 may then determine the level of risk using the events that occur along the new route so that a closed loop system is provided between the fourth processing system 226 for package transit planning and the second processing system 218 for risk determination via the model scoring.

For instance, at a pre-shipment phase for a package, an external factor such as a weather forecast of inclement weather at a facility at the time the package is expected to arrive or depart from the facility may show a risk for the package that triggers the fourth processing system 226 to create a new plan to route the package through a different facility. Likewise, a level of risk determined as a result of violating a package threshold during transit may trigger the fourth processing system 226 to create a new plan to route the package through a different facility in an attempt to reduce the amount of delay associated with subsequent events that the package will encounter. In both cases, the second processing system 218 assesses the risk of the package being delivered to the final location and that risk information is provided as feedback to the fourth processing system 226.

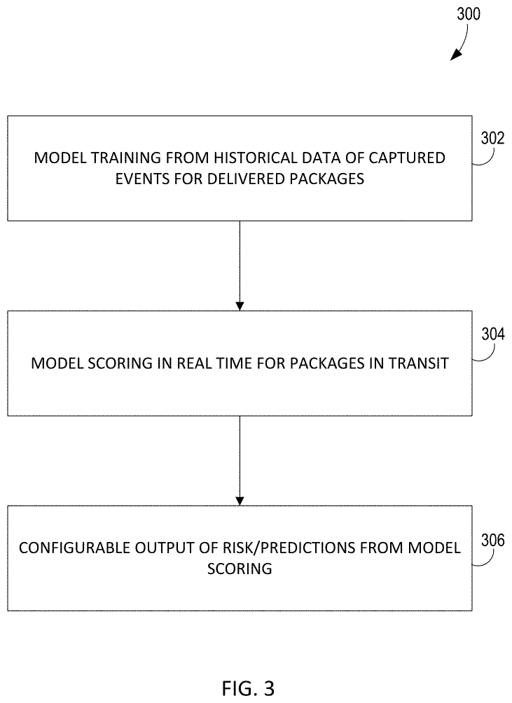

FIG. 3 shows a diagram demonstrating an overview 300 of the functions of the computer system 200. Here it can be seen that model training from the historical data captured events from the logistics network 100 occurs at an overview step 302. This relates to the operations of the first processing system 210 where the package fingerprint including the predicted events and the corresponding package threshold for each of the events is determined, along with associated levels of risk for different amounts of delay relative to the package threshold. The model scoring then occurs at an overview step 304. This relates to the operations of the second processing system 218 reactively comparing the package thresholds of the package fingerprint to current events once they happen as well as proactively comparing the package thresholds to predicted next events while waiting for them to happen. Then, the levels of risk that have been determined, as well as exceptions for missing events altogether, may be provided to the downstream consumers via configurable outputs on displayed user interfaces at an overview step 306.

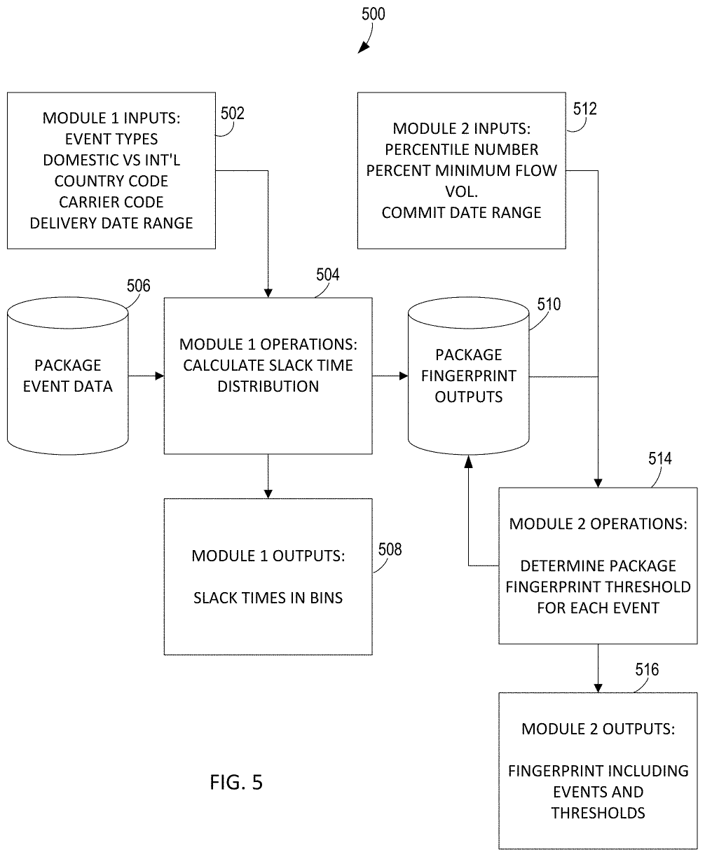

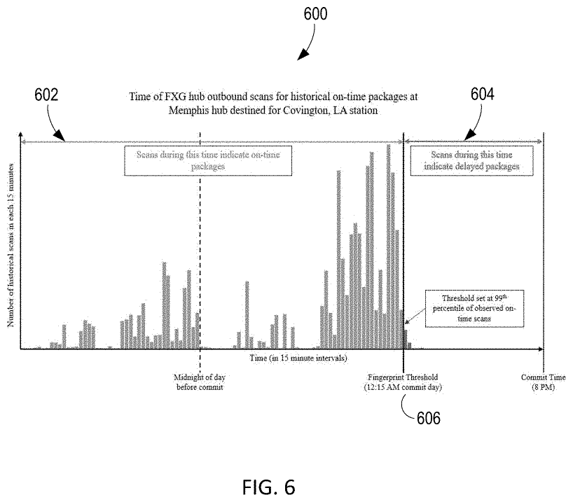

FIG. 4 is a flow diagram of the machine learning steps 400 being performed for model training purposes and that may be performed by the first processing system 210. Initially, the first processing system 210 extracts historical data that contains event type, event time, and event location for delivered packages over a particular timeframe at a step 402. The event type may specific whether the event is a pick-up, an arrival, a departure, a delivery and the like. The event time may specify a time of day and day of the week. The event location may specify the where the event occurs, including any facility within the logistics network 100 or any other location where the event occurs. Then a first module (module 1) being implemented by the first processing system 210 calculates a slack time for all events and categorizes the slack times into slack time bins at a step 404. A slack time is the amount of time between the time of an event and the stated time that is the latest time when the delivery should occur to be considered on-time. Categorizing the slack times of the events into slack time bins effectively builds a histogram, and an example is discussed in more detail below with reference to FIGS. 5 and 6.

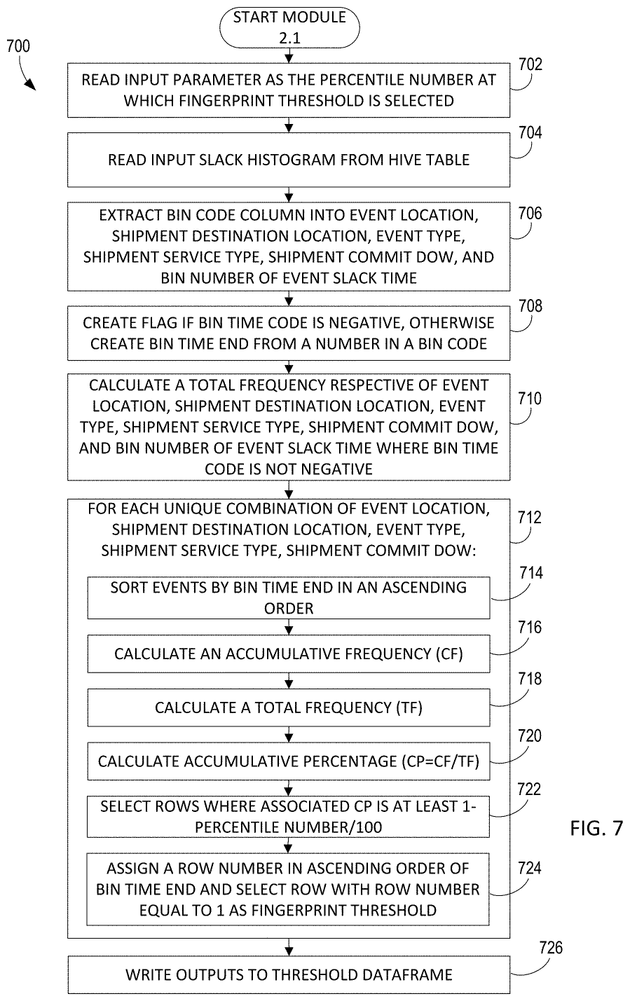

Once the slack times of all events from the historical data are categorized, then a first portion of a second module (module 2.1) finds a threshold for each predicted current event for a hypothetical package at step 406. The threshold of each predicted current event is found by calculating the desired percentile of all slack times specific to on-time packages for a location of the predicted current event. For this predicted current event of the hypothetical package, the hypothetical package has a final destination, is being shipped with a particular product type, and has a stated commit time for delivery on a particular day of the week. The product type relates to the level of service that is being provided for transporting the hypothetical package, such as a ground service, a next-day service, an international service, and so forth. Thus, each threshold being determined at step 406 is associated with a predicted current event for a hypothetical package that has these several characteristics, which then allows the proper selection of the predicted current event for inclusion in the package fingerprint for real packages having those same characteristics as the hypothetical package. An example of the flow of sub-steps taken to determine the thresholds as in step 406 are described in more detail below with reference to FIG. 7.

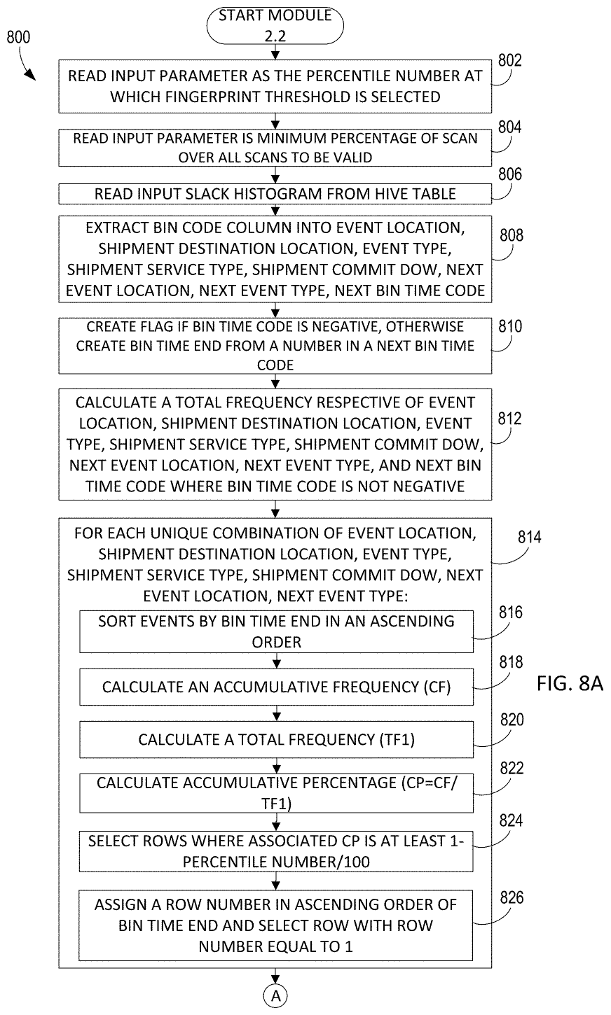

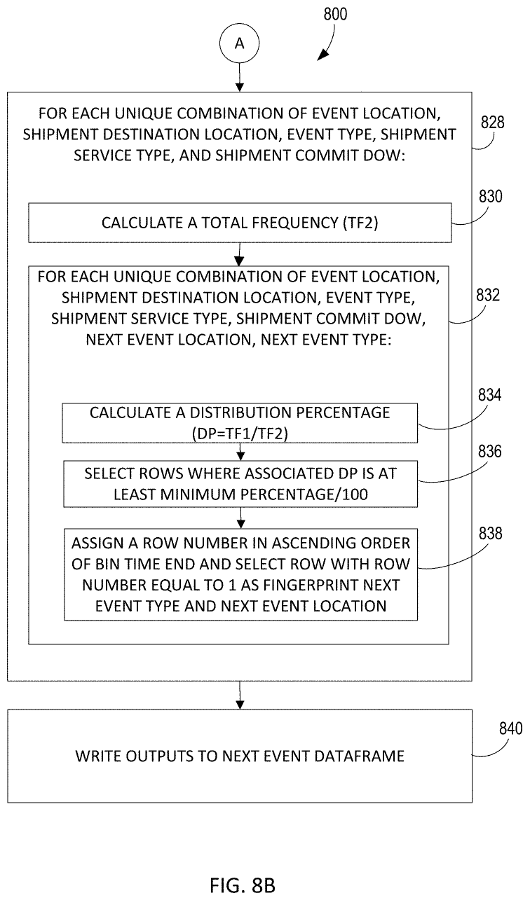

Once the package thresholds have been determined for all the predicted current events possible in the network, then a second portion of the second module (module 2.2) finds a predicted next event location and type that follows a particular current event at step 408. To find the predicted next event location and type that follows a particular current event, the threshold of all potential predicted next events that follow a particular current event is found using histograms of slack times for the potential predicted next events that follow the particular current event and again using the desired percentile to determine the thresholds of the potential next events. The potential next event having the latest threshold is chosen as the predicted next event location and type for the package fingerprint. An example of the flow of sub-steps taken to determine the predicted next event location and type as in step 408 are described in more detail below with reference to FIGS. 8A and 8B.

Once all of the predicted next events have been determined, then a third portion of the second module (module 2.3) combines the outputs of modules 2.1 and 2.2 at step 410. Thus, for a given predicted current event of a given hypothetical package having a determined threshold, module 2.3 joins the appropriate predicted next event location and type as well as the threshold for the predicted next event that has been determined in module 2.1. The threshold that is used with the predicted next event that has been chosen by module 2.2 is not the threshold found by module 2.2 but is instead the threshold that is calculated for that predicted next event location and type when that predicted next event location and type is considered a predicted current event in module 2.1. By using the output of module 2.1 as the threshold for each predicted next event, this removes any dependence on the predicted current event that preceded the predicted next event in finding the threshold for that predicted next event. This is relevant to reactive scoring of current events and proactive scoring of next events which is discussed below in relation to FIGS. 10-13. An example of the output of module 2.3 that combines predicted current events of module 2.1 and predicted next events of module 2.2 is shown immediately below in Table 1.

TABLE 1

| | | | | svc | | | next | next | | | | | |
|---|---|---|---|---|---|---|---|---|---|---|---|---|---|
| | event | dest | ent | desc | svc | | event | event | | | | | dest TZ |
| carrier | loc | loc | code | code | code | dow | loc | code | T_1 | freq_1 | T_2 | freq_2 | name |
| FX | ABEA | CHIA | PU | D | 3 | Wed | EWRHB | AR | 2,835 | 338 | 1,890 | 6,413 | US/Central |
| FX | EWRHB | CHIA | AR | D | 3 | Wed | EWRRA | DP | 1,890 | 6,413 | 1,215 | 7,321 | US/Central |
| FX | EWRRA | CHIA | DP | D | 3 | Wed | ORDR | AR | 1,215 | 7,321 | 675 | 63,065 | US/Central |
| FX | ORDR | CHIA | AR | D | 3 | Wed | CHIA | AR | 675 | 63,065 | 480 | 70,659 | US/Central |
| FX | CHIA | CHIA | AR | D | 3 | Wed | CHIA | OD | 480 | 70,659 | 360 | 64,735 | US/Central |
| FX | CHIA | CHIA | OD | D | 3 | Wed | CHIA | DL | 360 | 64,735 | 60 | 66,291 | US/Central |
| FX | CHIA | CHIA | DL | D | 3 | Wed | | | 60 | 66,291 | | | US/Central |

This package fingerprint for a hypothetical package shows that each predicted current event has a threshold T_1 (specified in minutes until the commit time) that has been determined in module 2.1 at step 406. Each predicted next event that follows a predicted current event has a threshold T_2 (specified in minutes until the commit time). However, it can further be seen that each predicted next event is followed by the same event but now as a predicted current event. In other words, once a predicted next event actually occurs, it is a predicted current event. Thus, the T_2 of a predicted next event following one predicted current event is equal to the T_1 of the following predicted current event.

As a specific example from the package fingerprint shown in Table 1 above, for the carrier entity FX, a first predicted current event occurs at facility ABEA with the type PU (i.e., a pick-up event) where the package is destined for a delivery address associated with the CHIA facility. The service description code D indicates domestic delivery service, service code 3 indicates a 2-day delivery, while a day of the week (dow) indicates a Wednesday delivery day. The first predicted current event has a threshold T_1 of 2835, meaning the pickup is expected to be 2835 minutes prior to the stated time of delivery for the service type purchased. The predicted next event that is expected to follow the predicted current event occurs at facility EWRHB as an arrival (AR) as determined by module 2.2 looking for all possible next events that follow the predicted ABEA PU current event. This predicted next event has a threshold T_2 of 1890 minutes prior to the stated time of delivery by this T_2 value was not found by module 2.2. The predicted current event that follows that predicted next event is the EWRHB arrival, which has a threshold T_1 of 1890, exactly the same as the T_2 value for the preceding predicted next event. Module 2.1 found the threshold T_1 of 1890 when evaluating the EWRHB arrival event as a current event. Module 2.3 then used the threshold T_1 value of 1890 for the EWRHB predicted current event as the threshold T_2 value for the EWRHB predicted next event to eliminate any dependency of the T_2 EWRHB threshold on the prior ABEA PU event.

An additional module portion 2.4 may be used in conjunction with the outputs of module 2.3 to append the destination time zone name, as shown above in Table 1. This allows later adjustment of the times to a common frame of reference such as Coordinated Universal Time (UTC) based on the time zones that apply for the location of each predicted event. This simplifies the application of thresholds as the events may cross from one time zone to the next.

Once the package fingerprint information is complete for all predicted events that may occur within the logistics network 100, a risk dimension table is created at a step 412 for all of the predicted events. This is done by calculating a risk of delay of the delivery for each potential range of time that an event occurs beyond the threshold for the event. For instance, the range may be an hour so the risk level is calculated for each hour that the event occurs after the threshold from the package fingerprint. The risk is specific to the characteristics of the predicted event and hypothetical package, including event location, event type, product or service type, number of days until the commit time, day of week of the commit time, and so forth.

FIG. 5 provides an illustration of the set of components used in the flow of FIG. 4 to find the predicted current events, predicted next events, and thresholds that are respective of event location, event type, product or service type, number of days until the commit time, day of week of the commit time, and so forth. Module 1 as described above for step 404 of FIG. 4 utilizes inputs 502 including event types, domestic versus international service type, the country code for the country in which the package is being transported, a carrier code to identify the carrier for any particular package, and a delivery date range for which to determine the slack times so that the slack times being categorized into bins are the correct slack times for a particular hypothetical package having certain characteristics. The module 1 operations 504 access the historical package event data 506 to calculate the slack time distribution for each event possible within the logistics network 100. The module 1 output 508 includes the slack time in bins to establish the slack time distribution which may be represented in histogram form 600 as shown in FIG. 6. It can be seen in the example of FIG. 6 that the histogram 600 includes slack times sorted into bins of 15-minute intervals. It will be appreciated that other intervals may be chosen but it has been found that 15-minute intervals provide sufficient resolution for determining an effective threshold.

This output of module 1 is then provided to module 2 along with module 2 inputs 512 that include a percentile number, a percent minimum flow volume, and a commit date range for the stated time of delivery. Module 2 operations determine the package fingerprint events, and thresholds for each event, including predicted current events and predicted next events as described in steps 406, 408, and 410 of FIG. 4. The output of module 2 is placed in storage 510 and contains the package fingerprint components including all the predicted events and corresponding thresholds, such as those shown above in Table 1 for a given hypothetical package.

Returning to FIG. 6, the histogram 600 further demonstrates how module 2.1 finds the threshold for a given current event. In this example, the event is an outbound scan from a hub for packages that are destined for a particular final location. Using a desired percentile of slack times, the threshold is then found. In this example, the desired percentile as indicated at 606 is the 99^{th} percentile which has shown to provide a valid threshold for determining risk of package delay. In this example, the 99^{th} percentile of observed on time scans is 12:15 AM on the commit day for delivery. Thus, it is presumed that any package leaving this particular hub after 12:15 AM on the commit day and headed for this particular final location will be at a level of risk of being delivered after the commit day. Thus, the packages with slack times in bins of area 602 are presumed to be on-time with no level of risk while the packages with slack times in bins of area 604 are presumed to be at risk of a delayed delivery.

FIG. 7 is a flow diagram showing an example 700 of the steps that may be followed when performing the function of module 2.1 to find the predicted current event thresholds for the package fingerprint. Module 2.1 begins at step 702 where the module 2.1 reads input parameters as the percentile number at which the fingerprint threshold for an event is selected. As described above for the example shown in FIG. 6, the percentile was the 99^{th}. The slack time distribution for a predicted current event as provided in the histogram is read as input from a database storing the histograms, such as a Hive table when Apache Hive is in use, at a step 704. The bin code column is extracted into event location, shipment destination location, event type, shipment service type, shipment commit day of the week, and bind number of event slack time at a step 706. A flag is created if the bin time code negative at a step 708. Then, a total frequency respective of event location, shipment destination location, event type, shipment service type, shipment commit day of the week, and bin number of event slack time where bin time code is not negative is calculated at a step 710.

At this point, a set 712 of steps are taken for each unique combination of event location, shipment destination location, event type, shipment service type, and shipment day of the week. At the first step 714 of the set 712, the events are sorted by bin time end in an ascending order. At the step 716 of the set 712, an accumulative frequency (CF) is calculated while at the step 718 of set 712, a total frequency (TF) is calculated. An accumulative percentage (CP) is then calculated at step 720 of set 712 as CP=CF/TF. The rows where the associated CP is at least 1—the percentile number (e.g., 99)/100 are selected at a step 722 of set 712. Then a row number is assigned in ascending order of bin time end and the row with the row number equal to 1 is selected as the fingerprint threshold for the predicted current event at step 724, where the predicted current event is defined as the unique combination of event location, shipment destination location, event type, shipment service type, and shipment commit day of the week. The predicted current events associated with the selected fingerprint thresholds for each are then written to a threshold dataframe at step 726 to conclude module 2.1.

FIGS. 8A-8B are a flow diagram showing an example 800 of the steps that may be followed when performing the function of module 2.2 to find the predicted next event location and type for the package fingerprint for a given predicted current event as determined in module 2.1. Initially, an input parameter is read as the desired percentile number for observed on-time scans at a step 802. This may be the same percentile, such as 99^{th}, as used in module 2.1 or it may be different since this threshold is used as a test to find the next event with the latest predicted next event after the given current event but is not used as the threshold for the predicted next event in the package fingerprint. Another input parameter is then read as the desired minimum percentage required for a predicted next event over all historical next events to be a valid predicted next event at step 804. This minimum percentage represents the minim flow volume for a potential predicted event to allow those predicted next events with a very low amount of occurrences to be filtered out of the pool of potential next events for a given current event. It has been found that 10 percent is an effective minimum percentage for such filtering but other minimum percentages are also applicable.

Once the input parameters have been read, the slack histogram data for each of the potential next events for the given predicted current event are read as input from a database storing the histograms, such as a Hive table where Apache Hive is in use, at step 806. This the allows a bin code column to be extracted into event location, shipment destination location, event type, shipment service type, shipment commit dow, next event location next event type, and next bin time code at a step 808. A flag is created if a bin time code is negative, other wise a bin time end is created from a number in a next bin time code at a step 810. Then a total frequency of respective of event location, shipment destination location, event type, shipment service type, shipment commit dow, next event location, next event type, and next bind time code where the bind time code is not negative is calculated at a step 812.

At this point, a set 814 of steps are performed for each unique combination of event location, shipment destination location, event type, shipment service type, shipment commit dow, next event location, and next event type. A first step 816 of the set 814, the events are sorted by bin time end in an ascending order. At the step 818 of the set 814, an accumulative frequency (CF) is calculated while at the step 820 of set 814, a first total frequency (TF1) is calculated. An accumulative percentage (CP) is then calculated at step 822 of set 814 as CP=CF/TF1. The rows where the associated CP is at least 1—the percentile number (e.g., 99)/100 are selected at a step 824 of set 814. Then a row number is assigned in ascending order of bin time end and the row with the row number equal to 1 is selected at step 826.

Once the row equal to 1 has been selected for each unique combination, a set of steps 828 are performed for each unique combination of event location, shipment destination location, event type, shipment service type, and shipment commit dow. At the first step 830 of the set 828, a second total frequency (TF2) is calculated. Then for each unique combination of event location, shipment destination location, event type, shipment service type, shipment commit dow, next event location, and next even type, a set 832 of steps nested within the set 828 are performed. At a step 834 a distribution percentage (DP) is calculated as DP=TF1/TF2. The rows where the associated DP is at least the minimum percentage (e.g., 10)/100 are selected at a step 836 of set 832 to thereby keep only those potential next events that meet this minimum flow volume. Then a row number is assigned in ascending order of bin time end and the row with the row number equal to 1 is selected as the predicted next event type and location at step 838, where the predicted next event for each predicted current event is defined as the unique combination of event location, shipment destination location, event type, shipment service type, and shipment commit day of the week that corresponds to the associated preceding predicted current event. This predicted next event type and location are written as output to a next event dataframe at step 840. As previously discussed, the package thresholds to be used in the package fingerprint for the predicted next events are determined separately by module 2.1 where the predicted next events are considered as predicted current events and module 2.3 then combines the outputs of modules 2.1 and 2.2 to produce the package fingerprint, such as the one shown above in Table 1 where threshold T_2 of a predicted next event is the same as the T_1 for the predicted current event that follows the predicted event because they are the same predicted event where the predicted next event (T_2) is monitored during proactive scoring and the following current event (T_1) is monitored during reactive scoring, respectively.

A specific example demonstrating how module 2.2 finds the location and type for the predicted next event goes as follows. A historical current event with occurring at a DENR event location that is of the departure type, has three potential next locations and event types in the historical data. For each of the three next potential locations and event types, the 99^{th} Percentile threshold time and the sample size are determined. For example, arrival event types at an ORDR event location happen 5% of time and the 99^{th} percentile threshold of this pair is at 10/1/19 5:30. An arrival event type at INDH event location and arrival event type at MEMH event location respectively happen 45% and 50% of time, and the 99^{th} percentile thresholds respectively are 10/1/19 1:45 and 10/1/19 00:00. Given this information, the arrival event type at the INDH event location is selected as predicted next event type and location for the current event of a departure from DENR because that predicted next event location and type has the sample size greater than 10% and its 99^{th} percentile threshold is the latest among those whose sample size is greater than 10%.

FIGS. 9A and 9B are a flow diagram showing an example 900 of the steps that may be followed when performing the function of the package risk table calculation sub-system 214 of the first processing system 210. At a first step 902, input parameters are read as the beginning and ending shipment dates of the packages of the historical data. The historical event data for packages having a shipment date within the beginning and ending shipment dates are then read as further input at step 904. The service type, commit dow, and service outcome (delivered on-time or delayed by a particular length of time) are extracted from the historical data for each package at a step 906. An event array is expanded at a step 908 for the information extracted. The data is then filtered to keep only the fingerprint eligible events at a step 910. For instance, any events that are unrelated to the predicted events of the logistics network 100 used in the package fingerprints are removed.

Once the historical event data has been filtered, it is ready to be applied to determine the levels of risk of the package being delivered after the stated time based on the lengths of delay beyond the threshold for each predicted event of the package fingerprints. At step 912, for each event of each package from the historical data, an event type, event location, a number of days from the event time to the commit date are determined, although with a maximum specific to each service type. For example, an express service type may have a maximum of three days while a ground service type may have a maximum of seven days. At step 914, the corresponding package fingerprint threshold is obtained for each event of each historical package. Then, step 916 determines whether any historical event for any package would be a violation of the package fingerprint threshold.

At this point, the amount of delay of each historical event of each package found in step 916 can be calculated at step 918 by finding the difference between the actual event time and the fingerprint threshold up to a desired maximum. For instance, the maximum delay may be capped at a level such as 10 hours where it is expected the risk level of the package being late is already very high. In this example, the amount of delay is calculated in terms of hours but it will be appreciated that other units of time could also be the basis of the determination depending upon the level of granularity desired. At step 920, for each historical event that has a fingerprint threshold violation, a fingerprint violation counter assigned to a set of matching events to which the event with the threshold violation belongs is incremented by one. Thus, the result of step 920 is a tally of the violations of the threshold for each specific set of matching events.

At step 922, for each historical event that has a fingerprint threshold violation and has a delivery that is late because it occurred after the stated time such as the commit time, a late delivery counter assigned to a set of matching events to which the event with the threshold violation and late delivery belongs is incremented by one. Thus, the result of step 922 is a tally of the late deliveries for each specific set of matching events. For each of these sets of matching events, a level of risk may be calculated as the value of the later counter divided by the value of the violation counter. Therefore, the output of the step 924 is a value between 0 and 1 to set the level of risk. This value may be multiplied by 100 if it is desired to express the output as a percentage. The outputs are then written to the risk table at a step 926.

An example of the risk table is shown below in Table 2 for an arrival (AR) event type at event location MEMEL This demonstrates that there may be some delay amounts that are not represented in the historical event data. For instance, delays of 1, 2, 3, and 6 hours are not represented in the historical data. However, these amounts of delays may occur in the future. Therefore, it may be appropriate to interpolate to find the amount of risk for any such missing delay amounts. A risk table that includes such interpolations is show below as Table 3. As the process of creating the risk table may be continuously performed by the first processing system 210 as historical data continues to be captured, the delay amounts from interpolation may eventually be replaced by delay amounts occurring in the historical data.

TABLE 2
(no interpolation):

| event | event | service | days till | commit | delay | total late | total | |
|---|---|---|---|---|---|---|---|---|
| loc | code | code | commit | dow | hour | package | package | risk |
| MEMH | AR | 20 | 1 | Tue | 4 | 8 | 19 | 42% |
| MEMH | AR | 20 | 1 | Tue | 5 | 39 | 54 | 72% |
| MEMH | AR | 20 | 1 | Tue | 7 | 2 | 2 | 100% |
| MEMH | AR | 20 | 1 | Tue | 8 | 1 | 1 | 100% |
| MEMH | AR | 20 | 1 | Tue | 9 | 5 | 5 | 100% |
| MEMH | AR | 20 | 1 | Tue | 10 | 174 | 225 | 77% |

TABLE 3
(after interpolation):

| event | event | service | days till | commit | delay | max delay | total late | total | |
|---|---|---|---|---|---|---|---|---|---|
| loc | code | code | commit | dow | hour | hour | package | package | risk |
| MEMH | AR | 20 | 1 | Tue | 0 | 10 | | | 8% |
| MEMH | AR | 20 | 1 | Tue | 1 | 10 | | | 17% |
| MEMH | AR | 20 | 1 | Tue | 2 | 10 | | | 25% |
| MEMH | AR | 20 | 1 | Tue | 3 | 10 | | | 34% |
| MEMH | AR | 20 | 1 | Tue | 4 | 10 | 8 | 19 | 42% |
| MEMH | AR | 20 | 1 | Tue | 5 | 10 | 39 | 54 | 72% |
| MEMH | AR | 20 | 1 | Tue | 6 | 10 | | | 86% |
| MEMH | AR | 20 | 1 | Tue | 7 | 10 | 2 | 2 | 100% |
| MEMH | AR | 20 | 1 | Tue | 8 | 10 | 1 | 1 | 100% |
| MEMH | AR | 20 | 1 | Tue | 9 | 10 | 5 | 5 | 100% |
| MEMH | AR | 20 | 1 | Tue | 10 | 10 | 174 | 225 | 77% |

The operations of the first processing system 210 to create the model as defined by the package fingerprints and associated risk table have been described above and the second processing system 218 may then score the model against real time data for real packages in transit in the logistics network 100 to find the level of risk for each predicted event both reactively and proactively. FIG. 10 is a flow diagram of an exemplary method 1000 of scoring the model against the real time event data of the real packages in transit. At a step 1002, the streaming of the live event data in real time for the real live packages in transit is received into the second processing system 218. At this point any proactive scoring for predicted next events from the package fingerprint are cancelled due to the occurrence of a predicted current event corresponding to the event data just received at step 1002. At a step 1006, for the new current event that has just occurred for the real package, the new current event is scored against the model by comparing the threshold of the predicted current event matching the current event that has actually occurred for the real package to find the amount of delay, if any, for the occurrence of the event beyond the threshold. This amount of delay may then be found for the predicted event in the risk table that matches the current event to reveal the corresponding level of risk specified in the risk table. This level of risk can then be made available to downstream processes.

Once the level of risk of the current event for the real package has been found, a proactive scoring may then be scheduled for the predicted next event defined for the current event in the package fingerprint at a step 1008. However, if the current event is a delivery type, then the process can conclude because delivery has occurred. If the current event is not a delivery type, meaning the package is still in transit, then the proactive scoring is scheduled and begins happening at the period specified by the schedule at step 1008. For instance, proactive scoring may be scheduled to execute every 15 minutes. It will be appreciated that the schedule may be other than every 15 minutes, where the amount of time may be chosen as a matter of balancing the resolution of the proactive score versus the amount of processing that is required of the second processing system 218 considering the potentially large scale of the logistics network 100 and the vast number of real packages in transit at any given time that are being scored against the model. Once the threshold for the predicted next event being scored has passed, a level of risk is assigned. The scheduled proactive scoring may then carry on with periodically updating the risk level based on an increase in the delay beyond the threshold. Once a new occurrence of an event for the package occurs, the flow of exemplary method 1000 returns to step 1002.

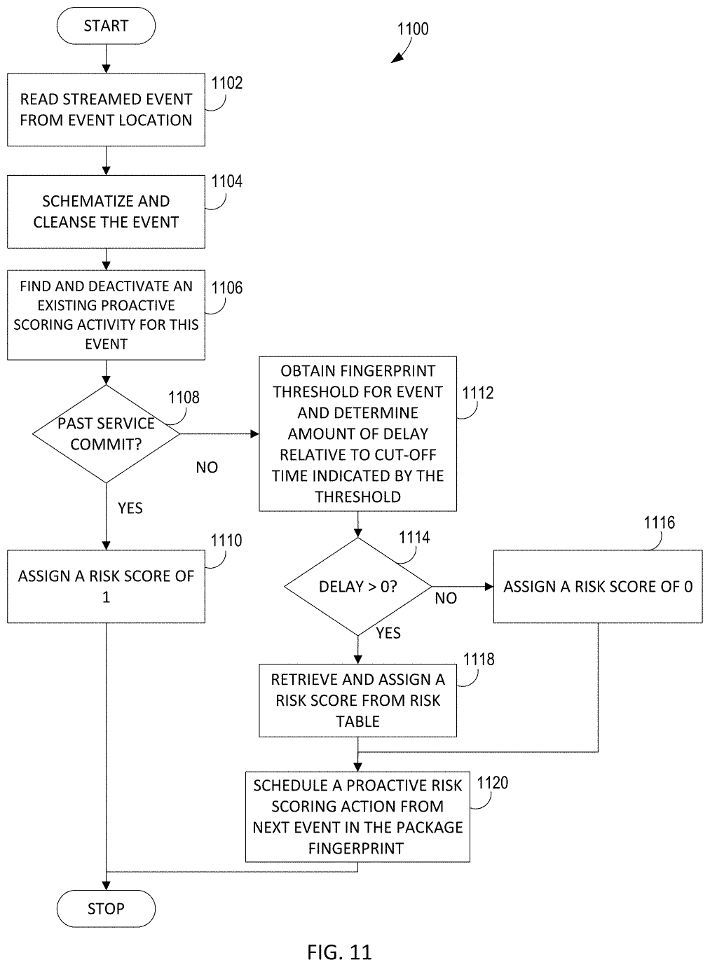

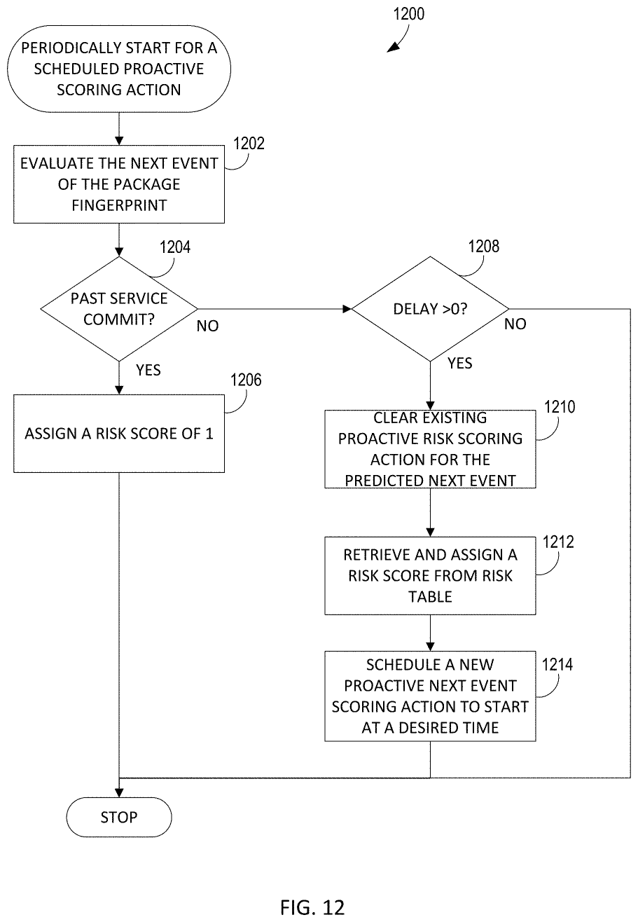

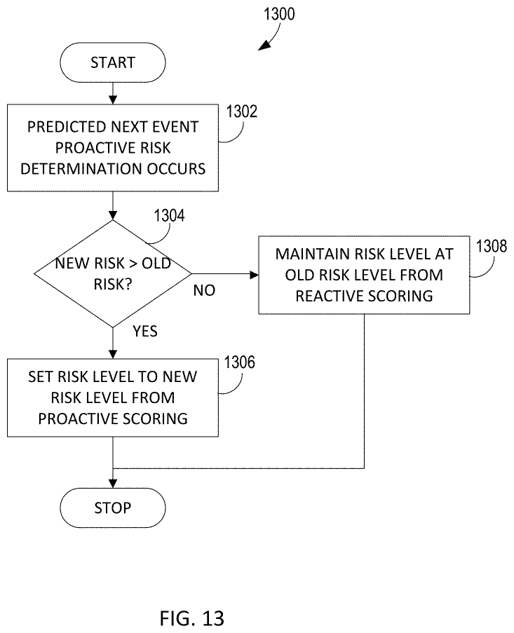

The proactive scoring is looking for packages that have not experienced a predicted next event yet so that the scoring of that event as a current event is not yet possible. The proactive scoring of step 1008 thereby allows the risk to be determined for the predicted next event prior to the predicted next event actually happening in the network 100, rather than finding the risk only once the event does happen via the reactive scoring at step 1006. Once a proactive risk assessment is performed at a scheduled time, risk aggregation may be used as shown in FIG. 13 in relation to the most recent reactive score and the current proactive score to determine whether the risk from the most recent proactive score or the risk from the existing reactive score is used as the level of risk for the package at that moment. However, once the predicted next event does happen and becomes the current event being reactively scored, that risk from the reactive score then becomes the level of risk for the package. A specific example of the steps of reactive scoring are described below in relation to FIG. 11 while a specific example of the steps of proactive scoring are described below in relation to FIG. 12.

FIG. 11 is a flow diagram showing an example 1100 of the steps that may be followed when performing the reactive scoring function of the second processing system 218. At a step 1102, the flow begins by reading a streamed event from the event location within the logistics network 100 that is directed to the second processing system 218. The streamed event may identify the package, the origin, the final location, the stated time for delivery known as the service commit, product/service type, and the delivery dow. At step 1104, the event may be schematized for into the particular data processing format needed and cleansed to filter out any events unrelated to scoring or events that are otherwise out of scope. At step 1106, any proactive scoring activity for this package that has been scheduled is deactivated since the event has occurred that can be reactively scored.

A decision is made at step 1108 regarding whether the time of the event is already past the service commit. If yes, then the package is already late and the risk of the package being late is therefore 1 or 100% and the reactive scoring ends. If the time of the current event is not already past the service commit, then the fingerprint threshold of the predicted current event corresponding to the actual current event streamed from the logistics network 100 is obtained at step 1112 and applied to the time of the event. The amount of delay of the real event relative to the cut-off time for the predicted current event indicated by the threshold is determined and a decision is made at step 1114 as to whether any delay relative to the threshold cut-off time exists.

If there is no delay beyond the threshold, then the package is on track for a delivery by the service commit. Therefore, the risk is assigned a score of zero at a step 116. If there is an amount of delay between the occurrence of the real current event relative to the threshold of the matching predicted current event from the package fingerprint, then the level of risk is retrieved from the risk table and this level of risk is assigned as the risk score for the package at a step 1118. After the completion of risk scoring at either step 1116 or 1118, a step 1120 then schedules the proactive scoring to activate for the predicted next event of the package fingerprint. The reactive scoring process for this current event is then complete and the reactive scoring is idle until the next event is streamed from a location within the logistics network 100.

One scenario that may occur when reactive scoring is that the real current event that has occurred in the logistics network 100 may not match the predicted current event from the package fingerprint. In other words, the transit plan may have sent the package to a different facility than was expected by the package fingerprint. This may result from ordinary business operations such as load balancing along routes of the logistics network and/or due to the application of pre-shipment risk analysis that led to an unexpected route through the logistics network being chosen. However, upon the current event occurring in the network, the reactive scoring may obtain the threshold associated with the real current event from the package fingerprint information that is available for the logistics network 100 and then carry on from that current event so that the reactive and proactive scoring can continue based on predicted next events and predicted current events from the actual current event until reaching the final destination location. The fingerprint may be different moving forward than initially expected by the package fingerprint because the next predicted event may be different based on the actual current location than the next predicted event that was based on the predicted current event location, but the process continues with reactive and proactive scoring based on the new package fingerprint predicted events and thresholds.

FIG. 12 is a flow diagram showing an example 1200 of the steps that may be followed when performing the proactive scoring function of the second processing system 218 that has been scheduled during the reactive scoring method of FIG. 11. The method starts periodically according to the schedule and begins at step 1202 where the predicted next event of the package fingerprint is evaluated. This evaluation compares the current time to the service commit time and to the threshold specified by the package fingerprint for this predicted next event and determines and amount of delay, if any, beyond the threshold. A decision step 1204 decides whether the current time is past the service commit time. If yes, then the package is already late and the risk of the package being late is therefore assigned as 1 or 100%, and this instance of proactive scoring for the next predicted event ends. If the time of the current event is not already past the service commit, then the amount of delay of the real event relative to the cut-off time for the predicted next event indicated by the threshold as previously determined is considered and a decision is made at step 1208 as to whether any delay relative to the threshold cut-off time exists.

If no delay exists, then this package is currently at no more risk at this point in time than when the most recent reactive scoring was performed. Therefore, the risk score is not changed, and this instance of the proactive scoring for the next predicted event ends. If delay relative to the threshold does exist, then in this example the scheduled proactive events are cleared for this package at a step 1210 because a new proactive schedule will be created instead. Then at step 1212, the level of risk for this predicted next event at this amount of delay beyond the threshold is found in the risk table and assigned to the package. A new proactive scoring action for the predicted next event may then be scheduled to start at a new time in the future. For instance, the new schedule of the proactive scoring for the package may be scheduled to start in one hour, which may correspond to the increments of the amounts of delay in the risk table, e.g., one-hour increments. The amount of time until the next proactive scoring starts is a balance between the amount of processing power required for the proactive scheduling relative to the value of a particular level of granularity for updates to the proactive score. This instance of proactive scoring then concludes.

FIG. 13 is a flow diagram showing an example 1300 of the steps that may be followed when performing the risk aggregation function of the second processing system 218. It may be desirable in some embodiments to use proactive scoring only for purposes of determining whether the risk of the package being delivered after the stated time is worse than the risk from the most recent reactive scoring and record that worse risk for the package. Therefore, when the proactive scoring of a predicted next event results in a lower risk score than was assigned by the most reactive scoring, the higher risk of the most reactive scoring is kept as the level of risk for the package. Thus, in such an embodiment it is only the actual occurrence of an event in the network that is reactively scored that can reduce the level of risk assigned to the package. The example 1300 demonstrates this implementation.

The example 1300 begins at a step 1302 where the proactive scoring of the next predicted event of the package fingerprint occurs to find a proactively scored level of risk. This proactively scored level of risk, i.e., the new risk, is compared against the most recent reactively scored level of risk for the package, i.e., the old risk, and a decision is made as to whether the new risk is greater than the old risk. If the new risk is not greater than the old risk, then the old risk found from the most recent reactive scoring is kept as the level of risk for the package at step 1308. If the new risk is greater than the old risk, then the new risk found from the most recent proactive scoring is kept as the level of risk for the package at step 1306. The risk aggregator example 1300 then concludes until the next proactive scoring for the package occurs.

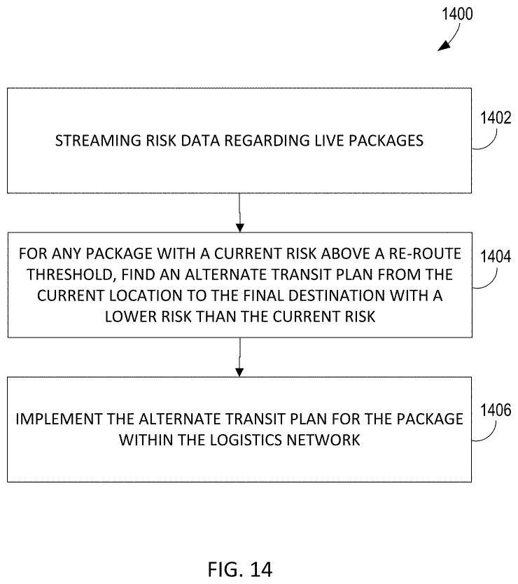

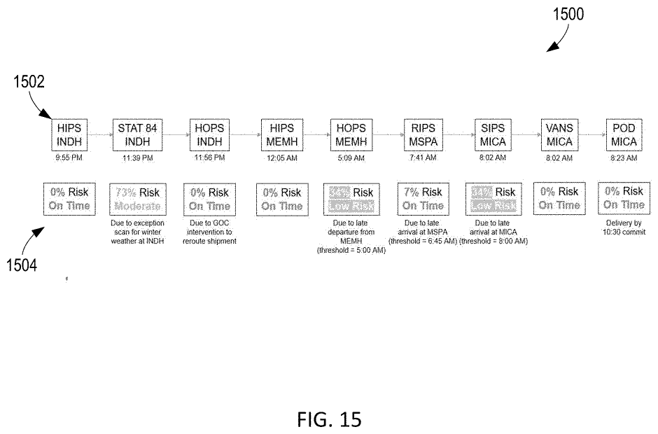

FIG. 14 is a flow diagram showing an example 1400 of the steps that may be followed by the fourth processing system 226 to re-route packages via changes to the transit plan being implemented by the logistics network 100 in response to levels of risk determined by the second processing system 218. The second processing system 218 may output the risk data for the live packages in transit as a stream that is directed to and received by the fourth processing system 226 at a step 1402. The fourth processing system 226 may then find an alternate transit plan from the current location of the package to the final destination location with a presumed lower risk than the current level of risk at a step 1404. For example, this step may involve implementing the alternate transit plan at a step 1406 where the package is directed to an atypical next event location which will differ from the predicted next event location of the fingerprint threshold and will then cause a new assessment of risk for the package that will likely differ from the prior one. This may be further effective when used in combination with pre-shipment risk determination from external factor risk analysis, such as whether weather or traffic to the chosen atypical next location is predicted to be a lower risk than that caused by weather or traffic to the more typical next location. Transit planning and the external risk factor analysis are discussed below in relation to FIGS. 15 and 16.

FIG. 15 shows an example 1500 of real package events 1502 and associated levels of risk 1504 of the package being delivered after the stated time that occur while the package is in transit. The package arrives at a location INDH and incurs a zero risk score. However, within a station at the INDH location, an exception occurs because of a weather risk which places the package at a 73% chance of being delivered after the stated commit time. However, the high level of risk causes a change to the transit plan for the package which re-routes the package which results in an updated risk prediction of zero as the new route does not suffer from the weather risk. Furthermore, the package fingerprint threshold that applies to the package departing from the INDH location and headed to the MICA final destination for the given commit time and level of service is not violated at the time of the departure event from INDH.

Along the route, a departure event from the MEMH location is 9 minutes later than the fingerprint threshold for this event (5:09 AM versus 5:00 AM) which causes a reactive risk score of 34% based on the risk table. However, a risk score of 34% is considered a low risk as the package is still more likely than not to reach the final location by the stated commit time of 10:30 AM. The package then arrives at the next event location MSPA 56 minutes later than the fingerprint threshold for this event (7:41 AM versus 6:45 AM) but the risk table indicates a risk score of only 7%, thus falling into the no risk category as the package is still very likely to reach the final destination by the stated commit time of 10:30 AM. This carries on with the risk continuing to fluctuate but never exceeding a low risk categorization and is delivered by the 10:30 AM stated commit time.

FIG. 16 is a flow diagram showing an example 1600 of the steps that may be followed by the fourth processing system 226 to factor in pre-shipment analysis using the external factors and associated risk. At step 1602, the package start location or origin, start time, final destination location, and product/service type are obtained. Then at step 1604, the expected path and timing of the product moving through the network 100 along the expected path is calculated using the predicted events in the package fingerprint for moving such a package to the final location. At step 1606 the external factors and associated risk information 1608 are obtained so that it can be identified whether the package will travel through an inclement condition, such as weather or traffic, based on the predicted locations and times calculated from the package fingerprint to then convert this information into a peripheral risk score.

This risk score can then be used by the transit planning system 226 to make pre-shipment determinations about the transit plan and whether a different plan would have a lower risk. An example was discussed above in relation to FIG. 15 and the weather causing a 73% risk level. Likewise, this example 1600 of pre-shipment determination of risk can also be applied by the second processing system 218 in real time at each location the real package visits along the route to determine the peripheral risk that the transit planning system 226 may consider when deciding to re-route the package from an location visited.

The risk information that is being determined for each package in transit within the logistics network 100 can be very useful for both the entity operating the logistics network 100 and also the entities that are expecting to receive the shipments. This is particularly true for packages that have special handling requirements like temperature control like certain vaccines and other medical related packages and/or have an extreme time sensitivity also like certain vaccines or medical related packages. Therefore, the risk information may be provided in a display format to the various interested parties to allow them to monitor the packages of interest. Furthermore, this allows personnel of the shipping entity to monitor points of failure within the network that give rise to the delays that impact the ability to deliver packages by the stated time.

FIG. 17 shows one example 1700 of a screen capture of such a user display provided by an application 222, 224 of FIG. 2 The example 1700 allows the user to apply various filters to control the information being displayed, such as a filter 1702 for a payer versus a shipper, a filter 1704 to choose an account of the payer or shipper that has been selected at filter 1702, and a service type for the package such as a ground service or an express service. Depending upon the filters selected, the example 1700 further displays a total number of packages in transit at a field 1708, a total number of packages at a sufficient level of risk to be of interest at a field 1710, and the number of packages that have experienced an exception, such as missing an event due to weather or other atypical factor at a field 1712. The example 1700 further includes a map 1714 that indicates a number of packages at risk for being delivered after that stated time to a location in a given geographical area such as within each state in the United States of America.

Providing this information in the example of 1700 allows person interested in monitoring packages the ability to focus on those packages that are at a sufficient level of risk, such as greater than 50%, to require attention. So, rather than monitoring all 446 packages in transit, this person may choose to focus on the 283 that are at a sufficient level of risk. Those packages can be identified by the user selecting the field 1710 to see all 283 or by selecting the geographic region from the map 1714 to focus on those at risk for that selected region. Furthermore, the user may focus on any given package at risk by selecting to view more information and in response to receiving the user selection, the third processing system then displays a list of packages at risk where the package of interest can be user selected from the list. Upon the third processing system receiving a selection of a specific package from the list, the third processing system may then display package-specific information.

It will be appreciated that packages for a given customer, such as a shipper or a recipient, the shipper has an account. Each of the packages may be tied to that account so that the third processing system provides the information for display to the shipper account only the risk information that pertains to the packages of that shipper account. Furthermore, the packages for a given shipper account may have different package-specific final locations and the events that happen for the packages during transport may be package-specific events. Thus, in the example of FIG. 17, the 446 packages of a shipper account may be destined for hundreds of different final locations. Furthermore, these packages may be traveling independently and so even for two packages with the same origin and final destination following the same transit path, they may be at different points along the transit path and thus encounter separate package-specific events that produce separate determinations of delay and risk. The example 1700 shows a screen capture taken at a first display time. The user may then choose to view the display at a subsequent second display time and the numbers may have changed as additional scoring has occurred for those packages. For instance, the number of packages at risk could be greater or less than the 283 that are at risk at the first display time shown in FIG. 17.

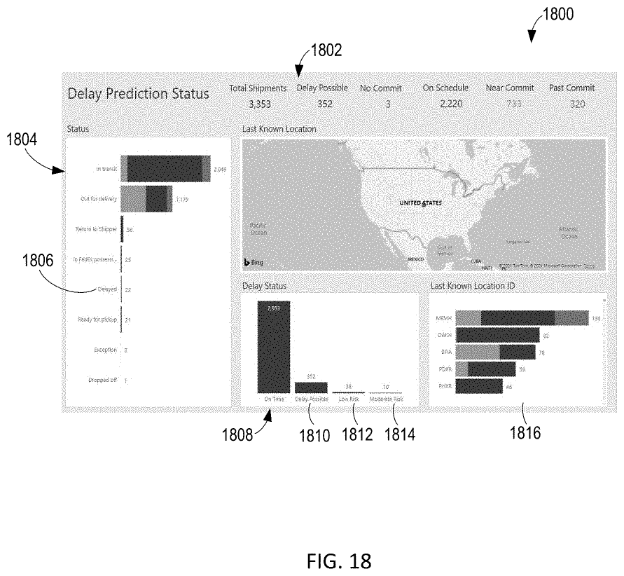

FIG. 18 shows another example 1800 of a screen capture of a user display provided by an application 222, 224 of FIG. 2. This example 1800 provides information 1802 including the total number of packages/shipments for given criteria, such as for a particular customer or for a particular location, a number of those packages that are at risk of being delayed, a number with no commit date, a number on schedule, a number near the commit date, and the number past the commit date. This allows personnel of the shipping entity to quickly see a snapshot for a given customer.

Bar charts within the example 1800 also provide the ability to quickly see the snapshot of shipment statuses in chart 1804 including the number of packages 1806 that are delayed. A delay status chart 1808 shows the number of packages at each categorization of risk of being delivered past the commit time, including the number of packages 1810 at a sufficient level of risk, such as at least 80%, where a delay is considered as possible, a number of packages 1812 at a low risk, such as lower than 40%, and a number of packages 1814 considered to be a moderate risk, such as between 40% and 80%. Other information, such as a chart 1816 showing the last know location of the packages is also shown. Thus, personnel of the shipping entity can gather a snapshot of information that provides insights into the operation of the network as well as the status of shipments for a given customer.

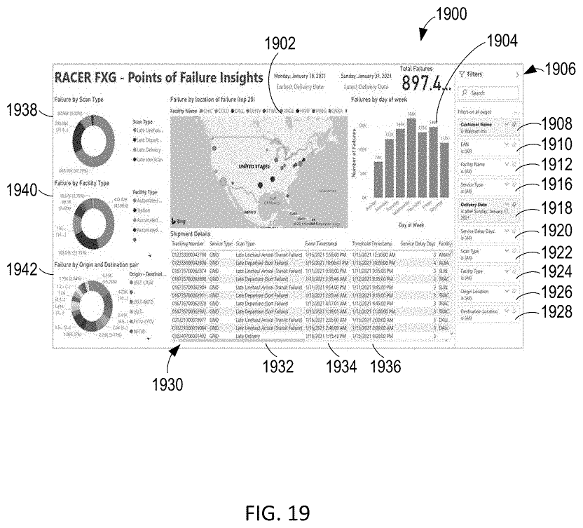

FIG. 19 shows another example 1900 of a screen capture of a user display provided by an application 222, 224 of FIG. 2. This example 1900 is particularly suited to personnel of the shipping entity looking to find points of failure with the logistics network 100 that cause delay resulting in the risk of the package being delivered after the stated commit time the example 1900 includes a heat map 1902 representing the locations within the logistics network 100 where the delays are occurring based on the number of violated fingerprint thresholds found during the reactive and proactive scoring. The delays may be shown as distributed within the days of the week as in the chart 1904.

A collection 1906 of filters may also be available for selection by a user to filter the information as desired and to allow the user to drill down in the data in various ways considering the risk data is stored in association with all of the other parameters of the packages including customer, origin, current location, final location, service type, stated commit time, and so forth. The filters may apply individually as well as in combination. A first field 1908 provides for selection of a customer name (i.e., the shipper) to filter the information provided for display. A second field 1910 provides for selection of an EAN code to filter the information provided for display. A third field 1912 provides for selection of a facility name to filter the information provided for display. A fourth field 1916 provides for selection of a facility name to filter the information for display. A fifth field 1918 provides for selection of a delivery date to filter the information for display. A sixth field 1920 provides for selection of a number of service delay days to filter the information for display. A seventh field 1922 provides for selection of a scan type, or event type as referred to above, that produced the event data to filter the information for display. An eighth field 1924 provides for selection of a facility type to filter the information for display. A ninth field 1926 provides for selection of an origin location to filter the information for display, and a tenth field 1928 provides for selection of a destination location to filter the information for display where using both fields 1926 and 1928 allows the user to specify an origin/destination pairing.

A table 1930 of information is displayed in addition to the heat map 1902 and chart 1904 to provide specific details to the user. For instance, the packages resulting from the application of the filters that appear in the table 1930 show the event type in column 1932, the event timestamp in column 1934, and the corresponding fingerprint threshold time stamp in column 1936. Thus, one can see the raw data that produces the risk of delays and can filter those as desired, such as by facility, customer, and the like. Other charts such as the donut charts 1938, 1940, and 1942 may be displayed to further illustrate the relative contributions to the delays, such as by scan type, facility type, and origin/destination pairs. Learning the points of failure by facility, by facility type, by scan type, by customer, by original/destination pairs and so forth allows the user to consider remedial actions to improve the operations of the logistics network 100.

Various examples and embodiments have been described above for creating and applying a network model in the form of package fingerprints to provide the ability to determine delayed delivery risks and exceptions for packages in transit and to allow monitoring of such packages at risk as well as monitoring the occurrences of delayed delivery risks and exceptions. The improvement to the computer systems associated with logistics networks include the ability to create these thresholds from the historical data and then apply these thresholds in real time to allow real time monitoring of the risk of delayed deliveries.

In summary, it should be emphasized that the sequence of operations to perform any of the methods and variations of the methods described in the embodiments herein are merely exemplary, and that a variety of sequences of operations may be followed while still being true and in accordance with the principles of the present invention as understood by one skilled in the art.

At least some portions of exemplary embodiments outlined above may be used in association with portions of other exemplary embodiments to enhance and improve logistics operations and related monitoring for packages at risk of a delayed delivery. For instance the risk based on reactive and proactive scoring may be used together with the pre-shipment risk analysis. Likewise either or both of these risk assessments may be used only for monitoring and information personnel or may be used to create a closed loop with the package transit planning. Moreover, at least some of the exemplary embodiments disclosed herein may be used independently from one another and/or in combination with one another and may have applications to devices and methods not disclosed herein. However, those skilled in the art will appreciate that the exemplary model training, model scoring, and related outputs as described above provide enhancements and improvements to technology used in logistics and shipment managing.

Those skilled in the art will appreciate that embodiments may provide one or more advantages, and not all embodiments necessarily provide all or more than one particular advantage as set forth here. Additionally, it will be apparent to those skilled in the art that various modifications and variations can be made to the structures and methodologies described herein. Thus, it should be understood that the invention is not limited to the subject matter discussed in the description. Rather, the present invention, as recited in the claims below, is intended to cover modifications and variations.

1. A computer system for monitoring the transport of packages within a logistics network, comprising:
an interface to at least one logistics network data source;
a first data storage module containing historical network data that is coupled to the interface to build the historical network data from a data feed from the logistics network data sources;
a second data storage module containing package transport model data;
a first processing system that accesses the data storage device and applies machine learning to the historical network data to train the package transport model data by:
capturing data-driven patterns inclusive of expected location of historical events, expected type of historical events, and expected time of historical events; and
from the data-driven patterns creating a set of predicted events for a hypothetical package being transported from a first location to a final location through the logistics network and determining a threshold for each of the predicted events in order for the hypothetical package to arrive at the final location by a stated time, each threshold relating to the expected time of a predicted event to occur for the hypothetical package where the predicted event relates to expected location and expected type, wherein the first processing system determines the threshold for each predicted event by determining for each predicted event that is a predicted current event a time at which a desired percentile of packages historically arrive on time and wherein the threshold is set based on that time for purposes of reactive monitoring of the predicted current event for the real package and wherein the first processing system further determines the threshold for each predicted event by determining for each predicted current event a predicted next event expected to follow the predicted current event by choosing a location of the predicted next event with a latest threshold from a set of potential next event locations where the threshold for each potential next event location for purposes of finding the latest threshold is determined by determining for each potential next event a time at which a desired percentile of packages moving from the location of the current event to the location of the potential next event historically arrive on time, and wherein the threshold that is latest identifies the predicted next event location and type for purposes of proactively monitoring for the predicted next event of the real package; and
a second processing system that is coupled to the interface to receive live data from the logistics network including data about a real package in transit, the second processing system accesses the transport model data from the second data storage to apply the thresholds to the predicted events for the real package and the second processing system assesses whether the real package is on schedule to be delivered to the final location by the stated time in relation to each predicted event based on application of the thresholds, wherein the second processing system reactively applies the thresholds for each predicted current event upon the predicted current event occurring for the real package to assess whether the real package is on schedule to be delivered to the final location by the stated time and proactively applies the thresholds for each predicted next event prior to the predicted next event occurring for the real package to further assess whether the real package is on schedule to be delivered to the final location by the stated time.

2. The computer system of claim 1, wherein the first processing system further calculates a table of risk amounts relative to amounts of delay beyond the threshold at any of the predicted events for the hypothetical package reaching the final location by the stated time.

3. The computer system of claim 2, wherein the second processing system determines a level of risk of the real package not being delivered to the final location by the stated time by accessing the table of risk amounts to find the amount of risk associated with the amount of delay beyond the threshold for a predicted current event that has been detected by the second processing system.

4. The computer system of claim 3, wherein the second processing system further determines the level of risk of the real package not being delivered to the final location by the stated time by accessing the table of risk amounts to find the amount of risk associated with the amount of delay beyond the threshold for a predicted next event that has not yet been detected by the second processing system.

5. The computer system of claim 3, further comprising a third processing system that receives the level of risk in association with the real package and upon receiving a request, generates a display that shows the level of risk for the real package.

6. The computer system of claim 3, further comprising a fourth processing module that receives the level of risk in association with the real package, wherein when the level of risk of the real package not being delivered to the final location by the stated time achieves a reroute threshold, the fourth processing module determines a different next event than a planned next event in the transit to the final location for the real package that that is expected to reduce the level of risk.

7. The computer system of claim 3, wherein the second processing system further receives external factor information and the second processing system determines a future risk to the real package reaching the location by the stated time based on the external factor information in relation to the predicted events expected to occur for the real package when in transit.

8. The computer system of claim 7, wherein the external factor information includes weather and traffic information that relates to the predicted events.

9. The computer system of claim 3, wherein the current event comprises the real package being scanned at a designated location within the logistics network.

10. The computer system of claim 9, wherein the current event further comprises an arrival scan at the designated location within the logistics network.

11. The computer system of claim 9, wherein the current event further comprises a departure scan from the designated locations within the logistics network.

12. (canceled)

13. The computer system of claim 1, wherein the desired percentile of packages that historically arrive on time to the predicted current event is a 99^{th} percentile.

14. (canceled)

15. The computer system of claim 2, wherein for a first shipper account having multiple packages being transported within the logistics network where at least some of the multiple packages have a first shipper location and a package-specific final location, while each package is being transported within the logistics network, the second processing system captures event data for each package at each package-specific current event, reactively compares the threshold from a corresponding predicted current event for each package to a time of an occurrence of the package-specific current event to find the level of risk of not being delivered to the final location by the package-specific stated time from the table of risks, and proactively compares the threshold from a corresponding predicted next event for each package to a current time, and
wherein the computer system further comprises a third processing system that receives outputs of the second processing system and the third processing system, for the first shipper account, provides information for display at a first display time that includes a total number of Response to the Office Action packages of the multiple packages that are at least at a particular level of risk of not reaching the package-specific final location by the package-specific stated time as of the first display time.

16. The computer system of claim 15, wherein while each package is being transported within the logistics network, the second processing system continues to capture event data for each package at each package-specific current event, reactively compare the threshold from a corresponding predicted current event for each package to a time of an occurrence of the package-specific current event to find the level of risk of not being delivered to the final location by the package-specific stated time from the table of risks, and proactively compare the threshold from a corresponding predicted next event for each package to a current time, and
wherein for the first shipper account, the third processing system provides information for display at a second display time subsequent to the first display time that includes the total number of packages of the multiple packages that are at least at the level of risk of not reaching the package-specific final location by the package-specific stated time as of the second display time.

17. The computer system of claim 15, wherein for the first shipper account, the third processing system provides information for display that includes information about the packages that are at least at the particular level of risk of not reaching the package-specific final location by the package-specific stated time, wherein the third processing system receives a selection of one of the packages being displayed and provides information for display specific to the selected package.

18. The computer system of claim 2, wherein the computer system further comprises a third processing system that receives outputs of the second processing system and the third processing system provides information for display at a first display time including aggregated information about packages that are at least at a particular level of risk of not reaching the package-specific final location.

19. The computer system of claim 18, wherein the logistics network includes a plurality of facilities and the third processing system provides for selection of the particular facility to filter the information provided for display.

20. The computer system of claim 18, wherein the third processing system provides for selection of a particular event type to filter the information provided for display.

21. The computer system of claim 19, wherein each facility has a particular type and wherein the third processing system provides for selection of the particular facility type to filter the information provided for display.

22. The computer system of claim 18, wherein the third processing system provides for selection of an origination of packages to filter the information provided for display.

23. The computer system of claim 18, wherein the third processing system provides for selection of the final location of packages to filter the information provided for display.

24. The computer system of claim 18, wherein the third processing system provides for selection of the stated time of delivery of packages to filter the information provided for display.

25. The computer system of claim 18, wherein the third processing system provides for selection of a service type for packages to filter the information provided for display.

26. The computer system of claim 18, wherein the third processing system provides for selection of a shipper of packages to filter the information provided for display.

27. The computer system of claim 18, wherein the third processing system provides information for display that includes the number of real packages at least at the particular level of risk grouped by each day of the week during which the predicted event threshold occurred that is the basis for the particular level of risk for the real packages.

28. A computer-implemented method for monitoring the transport of packages within a logistics network, comprising:
applying machine learning to historical network data for the logistics network to train package transport model data by:
capturing data-driven patterns inclusive of expected location of historical events, expected type of historical events, and expected time of historical events; and
from the data-driven patterns creating a set of predicted events for a hypothetical package being transported from a first location to a final location through the logistics network and determine a threshold for each of the predicted events in order for the hypothetical package to arrive at the final location by a stated time, each threshold relating to the expected time of a predicted event to occur for the hypothetical package where the predicted event relates to expected location and expected type, wherein the first processing system determines the threshold for each predicted event by determining for each predicted event that is a predicted current event a time at which a desired percentile of packages historically arrive on time and wherein the threshold is set based on that time for purposes of reactive monitoring of the predicted current event for the real package and wherein the first processing system further determines the threshold for each predicted event by determining for each predicted current event a predicted next event expected to follow the predicted current event by choosing a location of the predicted next event with a latest threshold from a set of potential next event locations where the threshold for each potential next event location for purposes of finding the latest threshold is determined by determining for each potential next event a time at which a desired percentile of packages moving from the location of the current event to the location of the potential next event historically arrive on time, and wherein the threshold that is latest identifies the predicted next event location and type for purposes of proactively monitoring for the predicted next event of the real package;
applying the thresholds to the predicted events for the real package by reactively applying the thresholds for each predicted current event upon the predicted current event occurring for the real package and by proactively applying the thresholds for each predicted next event prior to the predicted next event occurring for the real package to further assess whether the real package is on schedule to be delivered to the final location by the stated time;
assessing whether the real package is on schedule to reach the final location by the stated time in relation to each predicted current event and each predicted next event based on applying the thresholds;
calculating a table of risk amounts relative to amounts of delay beyond the threshold at any of the predicted events for the hypothetical package reaching the final location by the stated time;
determining a level of risk of the real package not being delivered to the final location by the stated time by accessing the table of risk amounts to find the amount of risk associated with the amount of delay beyond the threshold for a current event that has been detected; and
determining the level of risk of the real package not being delivered to the final location by the stated time by accessing the table of risk amounts to find the amount of risk associated with the amount of delay beyond the threshold for a predicted next event that has not yet been detected.

29. The computer-implemented method of claim 28, wherein for a first shipper account having multiple packages being transported within the logistics network where at least some of the multiple packages have a first shipper location and a package-specific final location, while each package is being transported within the logistics network, capturing event Response to the Office Action data for each package at each package-specific current event, reactively comparing the threshold from a corresponding predicted current event for each package to a time of an occurrence of the package-specific current event to find the level of risk of not being delivered to the final location by the package-specific stated time from the table of risk amounts, and proactively comparing the threshold from a corresponding predicted next event for each package to a current time to further find the level of risk of not being delivered to the final location by the package-specific stated time from the table of risks, and the computer-implemented method further comprising:
providing information for display at a first display time that includes a total number of packages of the multiple packages that are at least at a particular level of risk of not reaching the package-specific final location by the package-specific stated time as of the first display time.

30. The computer-implemented method of claim 29, wherein for the first shipper account, providing information for display that includes information about the packages that are at least at the particular level of risk of not reaching the package-specific final location by the package-specific stated time, receiving a selection of one of the packages being displayed, and providing information for display specific to the selected package.
